(19) United States
(12) Patent Application Publication
(10) Pub. No.: US 2012/0002062 A1
(43) Pub. Date: Jan. 5, 2012

(54) MODULAR AND INTEGRATED EQUIPMENT STABILIZING SUPPORT APPARATUSES

(76) Inventors: Garrett W. Brown, Philadelphia, PA (US); Colin Alan Campbell, South Pasadena, CA (US); H. Robert Orf, Simi Valley, CA (US); Ellen Shire, Philadelphia, PA (US)

(21) Appl. No.: 13/142,941

(22) PCT Filed: Jan. 5, 2010
(86) PCT No.: PCT/US10/20101

§ 371 Date: Sep. 16, 2011

Related U.S. Application Data
(60) Provisional application No. 61/142,503, filed on Jan. 5, 2009.
(60) Provisional application No. 61/177,455, filed on May 12, 2009.

(51) Int. Cl. H04N 5/228; B23P 11/00

(52) U.S. Cl. 348/208.99; 29/428; 348/E05.024

(57) ABSTRACT

An image-capture device stabilizer comprising a plurality of frictionally engaged components. The components are, or are configurable into, parts such as an image-capture device platform, a gimbal apparatus, and one or more balancing arms. The image-capture device stabilizer is pre-balanced for a specific image-capture device, and can be constructed to be suitable with an image-capture device weighing less than 1 lb. The image-capture device stabilizer can be provided in a kit. The invention also includes a method of fabricating an image-capture device stabilizer.

This application is a non-provisional application of U.S. provisional application 61/142,503, filed Jan. 5, 2009, and U.S. provisional application 61/177,455, filed May 12, 2009.

### FIELD OF THE INVENTION

The invention relates to apparatuses that are used to balance and stabilize objects including for example, hand-held video cameras, devices capable of capturing moving or still images, and other non-image related objects or equipment. The stabilizer isolates a user's motion from the image capture device to enable capture of a clear, focused image.

### BACKGROUND OF THE INVENTION

A conventional image-capture stabilizer requires adjusting and weighting it to properly balance the apparatus. Providing stabilizers unique to specific image-capture device models has not been commercially feasible because of the expense in doing so, and the number of stabilizers that would have to be offered. Gearing up to manufacture a stabilizer each time a new device model is introduced is time consuming and expensive, and it is difficult to determine which device models will have the longevity that will justify the expense.

Traditional stabilizers are often not suitable for lighter-weight devices, such as those weighing under one pound, for example. Because the balance of the stabilizer is key, suitable materials are limited to those that could retain their geometry to maintain balance. Limitations on component connection mechanisms available follow the limitations on materials.

Thus, a stabilizer is needed that is suitable for lightweight and ultra-lightweight image-capture devices, can be made of reasonably priced materials, and will reduce the necessity to adjust and fine tune the apparatus to achieve proper balance and stabilization.

### SUMMARY OF THE INVENTION

An illustrative embodiment of the invention includes an image-capture device stabilizer, which comprises a plurality of frictionally engaged components. The components are, or are configurable into, various parts, such as an image-capture device platform, a gimbal apparatus, having a handle and a gimbal, and one or more balancing arms. The image-capture device platform is frictionally engaged with the gimbal apparatus, which is positioned substantially at the center of gravity of the image-capture device stabilizer when engaged with an image-capture device. The balancing arm(s) are frictionally engaged with the image-capture device platform. One or more weighted components are part of or are frictionally engaged with the balancing arm. The image-capture device stabilizer is pre-balanced for a specific image-capture device. Advantageously, the image-capture device can be constructed to be suitable with an image-capture device weighing less than 1 lb.

In an exemplary embodiment of the invention, the image-capture device stabilizer includes two or more frictionally engaged components wherein one or more have coupling elements in the form of protrusions, and one or more have complimentary coupling elements in the form of recesses. The protrusions are interchangeably insertable in the recesses.

The image capture device stabilizer may also have an image-capture device integrated with the stabilizer. One or more auxiliary components can also be integrated with the stabilizer.

The invention also includes a kit for creating an image-capture device stabilizer comprised of frictionally engageable components, and a method of fabricating an image-capture device stabilizer.

### DESCRIPTION OF THE DRAWINGS

Illustrative embodiments of the invention are best understood from the following detailed description when read with the accompanying drawings.

FIG. 1 depicts a modular stabilizer according to an illustrative embodiment of the invention.

FIG. 2 depicts another view of the modular stabilizer of FIG. 1 according to an illustrative embodiment of the invention.

FIG. 3 depicts a modular stabilizer according to another illustrative embodiment of the invention.

FIG. 4 shows a close up view of a portion of the stabilizer of FIG. 3.

FIG. 5 depicts a modular stabilizer according to a further illustrative embodiment of the invention.

FIG. 6A depicts an integrated image-capture device and stabilizer in a folded position according to an illustrative embodiment of the invention.

FIG. 6B depicts an integrated image-capture device and stabilizer in an unfolded position according to an illustrative embodiment of the invention.

FIG. 7 depicts a device holder according to an illustrative embodiment of the invention.

FIG. 8 depicts a device holder engaged with a stabilizer according to an illustrative embodiment of the invention.

FIG. 9 depicts a device holder with a weight according to an illustrative embodiment of the invention.

### DETAILED DESCRIPTION OF THE INVENTION

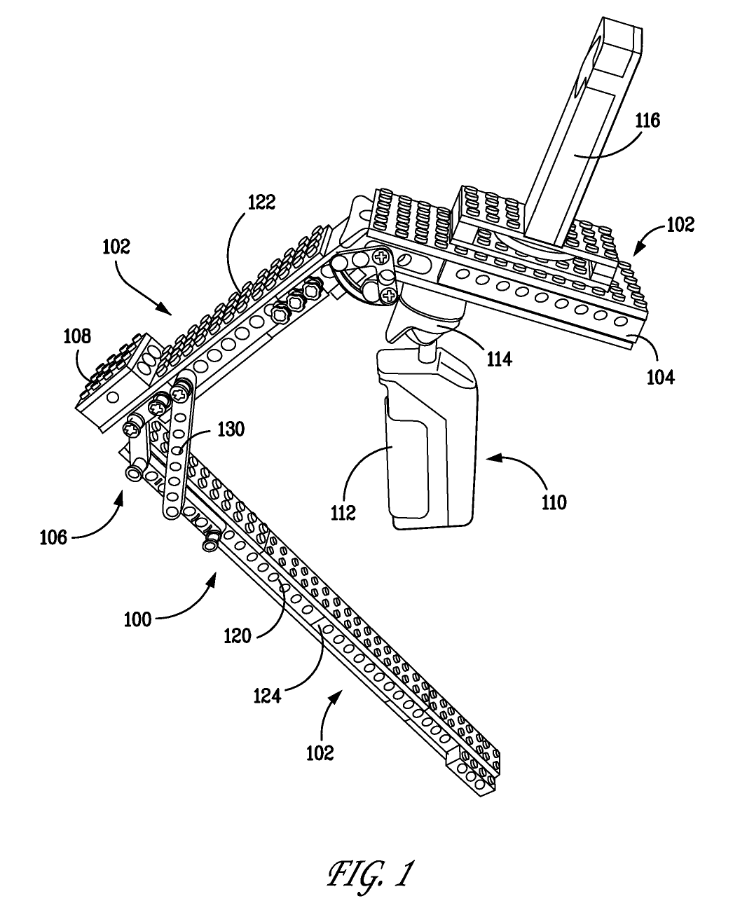

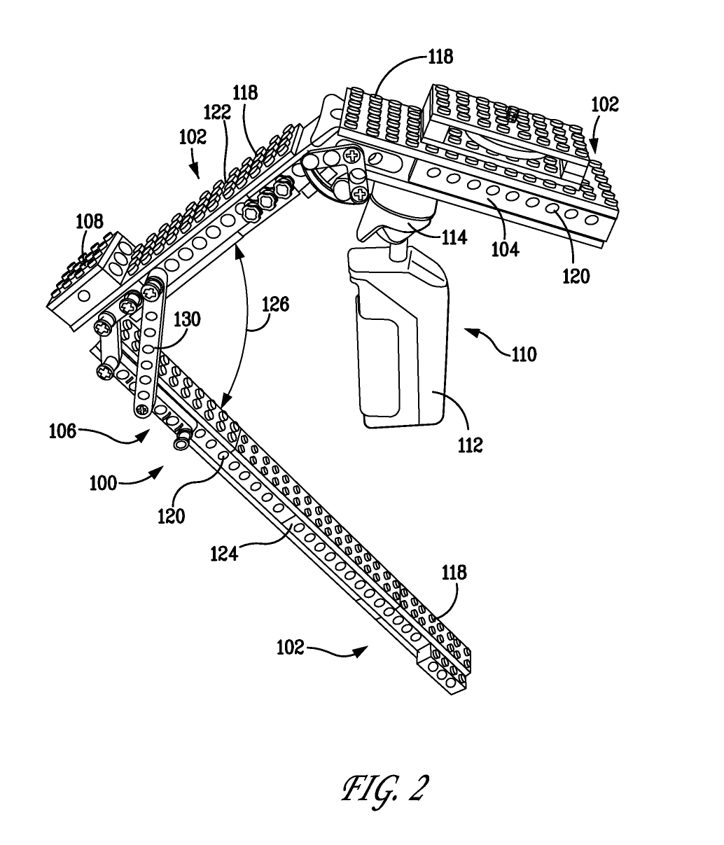

FIGS. 1 and 2 depict an illustrative embodiment of the invention that includes an equipment stabilizer 100 comprising a plurality of frictionally engageable components 102 configured into various parts of the stabilizer. The phrase “frictionally engageable” as used herein includes parts that are deemed press fit, force fit, or interference fit, wherein there is a negative allowance, i.e. a recess inner measurement (such as diameter for example) in one part is slightly smaller than an outer dimension (such as a diameter) in a protrusion that is inserted or fitted into the recess. Frictionally engageable parts need not have a negative allowance, but can also be made of materials that have sufficient friction between one another to keep them from pulling apart under conditions of use. The embodiment will be described in terms of an illustrative use with an image-capture device. Stabilizers according to embodiments of the invention may be used, for example, with various types of cameras, including lightweight and ultra-lightweight cameras, camcorders, video and still cameras, web cameras, multi-use devices such as iPhones or other mobile phone devices, personal digital assistants or other devices having image-capture capabilities, including still and video.

The stabilizer components can include for example, a device platform 104 to support the device, a balancing arm 106 attached to the platform, weights or weighted components 108 and a gimbal apparatus 110. Device platform 104 may be a single component or be formed of a plurality of engageable parts. Device platform 104 is preferably frictionally engaged with gimbal apparatus 110, which generally has a handle 112 and a gimbal 114. The term “gimbal apparatus” is used broadly, and includes any mechanism compatible with the other components of the apparatus, and which isolates unwanted movement from the device. Gimbal apparatus 110 is positioned at or near the center of gravity of the camera stabilizer, as calculated when an image-capture device 116 is engaged with the stabilizer apparatus. Balancing arm 106 and the weighted component(s) 108 are also frictionally engaged with device platform 104 in an illustrative embodiment of the invention. Weighted component(s) 108 can be part of the balancing arm components or separate pieces attachable to arm components so in essence the weights are integrated into the system. The stabilizer, once assembled, is preferably configured to balance a specific image-capture device. In this manner, the user will have little or no adjustments to make to correctly balance the apparatus and stabilize the image-capture device.

In an exemplary embodiment of the invention, the camera stabilizer components are sold in a kit so the user can assemble the camera stabilizer. Each kit is preferably specific to a certain device model, or configurable to a group of selected device models. Various parts of the stabilizer may be manufactured to a single standard that is compatible with stabilizers of various configurations. For example, the gimbal apparatus can be of standard dimensions and/or engagement mechanism that are compatible with different stabilizers. In an illustrative embodiment of the invention the kit includes two or more of the parts described herein. In an exemplary embodiment of the invention, the kit includes a gimbal assembly having a handle and a gimbal; one or more frictionally engageable components configurable into an image-capture device platform, the image-capture device platform frictionally engageable with the gimbal apparatus, and positionable at the center of gravity of the image-capture device stabilizer as calculated when engaged with an image-capture device; a plurality of frictionally engageable components configurable into a balancing arm, the balancing arm frictionally engageable with the image-capture device platform; and one or more weighted components frictionally engageable with the balancing arm; wherein the image-capture device stabilizer is pre-balanced for a specific image-capture device.

The modular components can be constructed so that the same components can be used for many or all designs, but in different configurations or by using different portions of the group of components. This simplifies manufacturing as compared to conventional camera stabilizers, which require machine retooling for different designs. It also allows for a single kit to provide stabilizers for a plurality of devices.

With the introduction of lightweight and ultra-lightweight devices, non-traditional stabilizer materials such as various types of plastic can now be used to a greater extent, and thus can more easily enable use of frictionally engageable components. Such components can flex sufficiently to snap into place, but will maintain their geometry under the weight and use of the device. Plastics would generally be appropriate for use even with very lightweight devices, such as those weighing less than about 1 lb. Illustrative weight ranges include: about 1-6 oz; and about 3-5 oz.

Not all stabilizer components need to be frictionally engageable with other components. Some or all components can be threadedly engageable with one another, engageable with pins or magnets, or attachable/detachable through other mechanisms. However, frictionally engageable components generally lend themselves to quick and easy assembly of the stabilizer, and substitution or addition of various components in a group to adapt the stabilizer to different image-capture devices. Before now, frictionally engageable components were not considered because the weight of image-capture devices necessitated more secure connections. The use of frictionally engageable components is suitable for example, for devices weighing less than 1 lb, and even those weighing less than 0.5 lbs. Recognition of this has enabled the inventors to build stabilizers specific to particular devices because it can now be done relatively inexpensively because various parts can be manufactured that can be used in more than one specific device. So for example, you may be able to manufacture X number of parts that, when all or some are connected provide a stabilizer for device A, and then use either the same parts connected differently or a different portion of the parts to create a stabilizer specific to device B. This is in contrast to present technology, which if applied to making a stabilizer specific to a particular device, would require for example, one or more of the following: unique arm component, unique gimbal apparatus; and unique platform.

In a particular embodiment of the invention, the platform is adjustable about three axes. Conventional platforms have X-Y platform adjustability. By adding an adjustment along the Z-axis, the gimbal apparatus can be raised or lowered with respect to the platform. This can provide additional balancing configuration options. Adjustments can be made by adding or removing components or providing an otherwise adjustable platform or mount.

FIGS. 1 and 2 depict an illustrative embodiment of the invention in which two or more of the frictionally engaged components comprise one or more first frictional coupling elements in the form of protrusions 118, and one or more second frictional coupling elements in the form of recesses 120 complimentary to protrusion 118, wherein protrusions 118 are interchangeably insertable in recesses 120.

In an illustrative embodiment of the invention, protrusions 118 are spaced about ¼ inch apart from center to center, and recesses 120 are spaced about ¼ inch apart from center to center. Other spacing and sizes are within the spirit and scope of the invention.

In an illustrative embodiment of the invention, protrusions 118 are cylindrical and have an outer diameter of approximately ⅛ inch. Recesses 120 have a minimally larger inner diameter to allow a snap fit with protrusions 118.

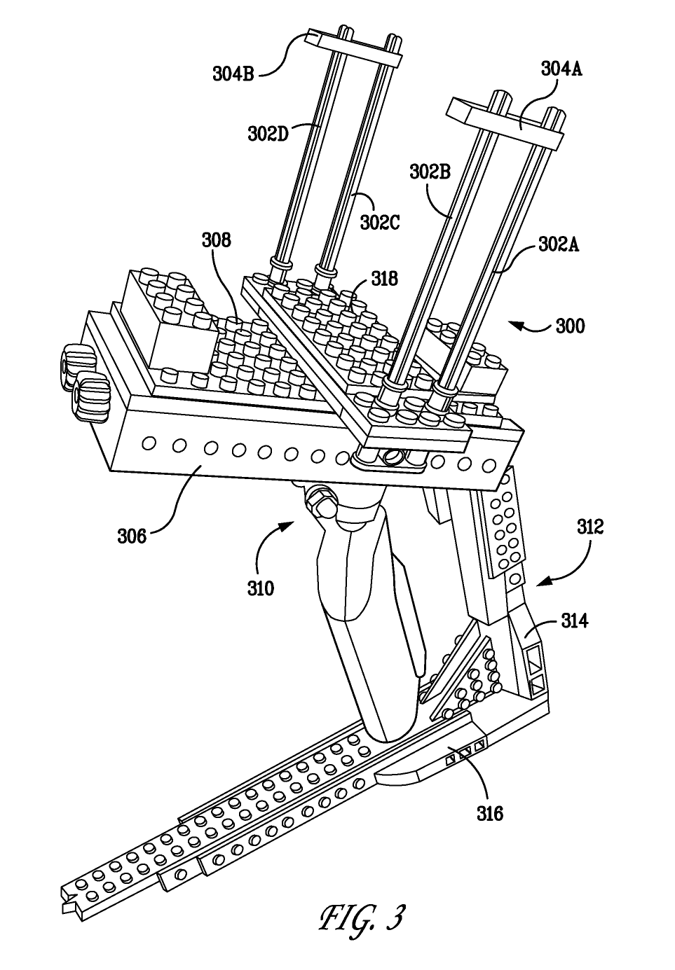

The platform may be engageable with a device having a tapped hole, by having a threaded member either fixedly or removable attached to the platform, such as with the device shown in FIG. 1. The platform may also be made to be engageable with a device not having a tapped hole. FIG. 3 depicts an example of a holder 300 that can accommodate an image-capture device within uprights 302A-D. Cross bars 304A-B are slideable along uprights 302A-D to secure the image-capture device into holder 300. Holder 300 is moveable on platform 306 if necessary by frictionally engageable protrusions 308 on platform 306 that are complimentary to recesses on the underside of stage 318. Gimbal apparatus 310 is also frictionally engaged with platform 306. Arm 312 is also attached to platform 306.

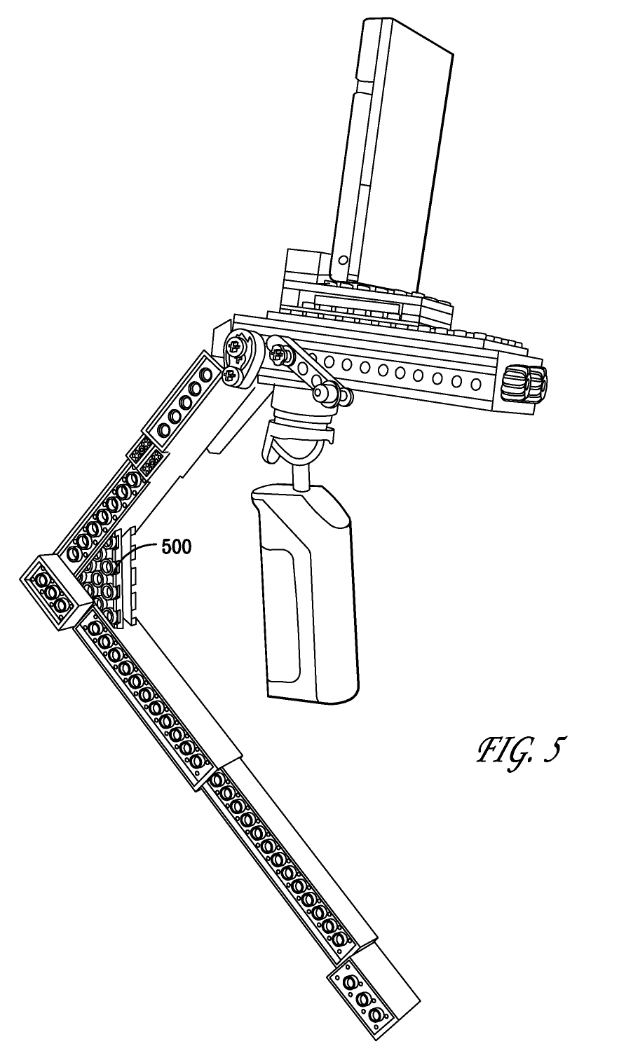

FIG. 3 shows weights 314, 316 that are frictionally engaged with balance arm 312. FIG. 5 depicts another illustrative embodiment of the invention in which the weights are not present on the arm.

A device holder compatible with the device for which the stabilizer is designed can be disposed on the platform or incorporated therein. A holder can also be designed to accommodate more than one device type. The image-capture device holder can be configured to releasably hold the image-capture device to the platform.

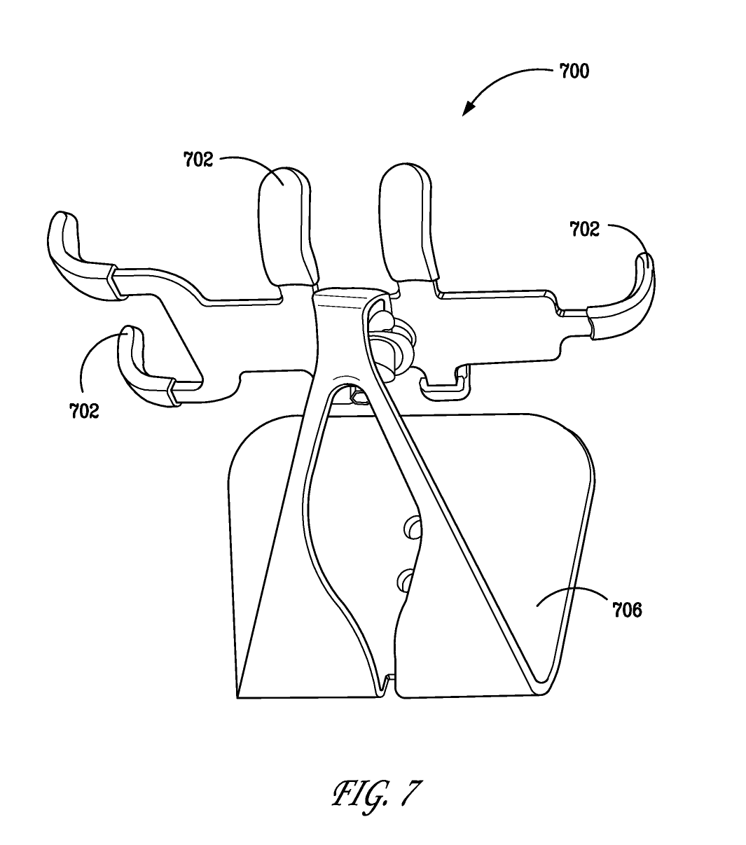

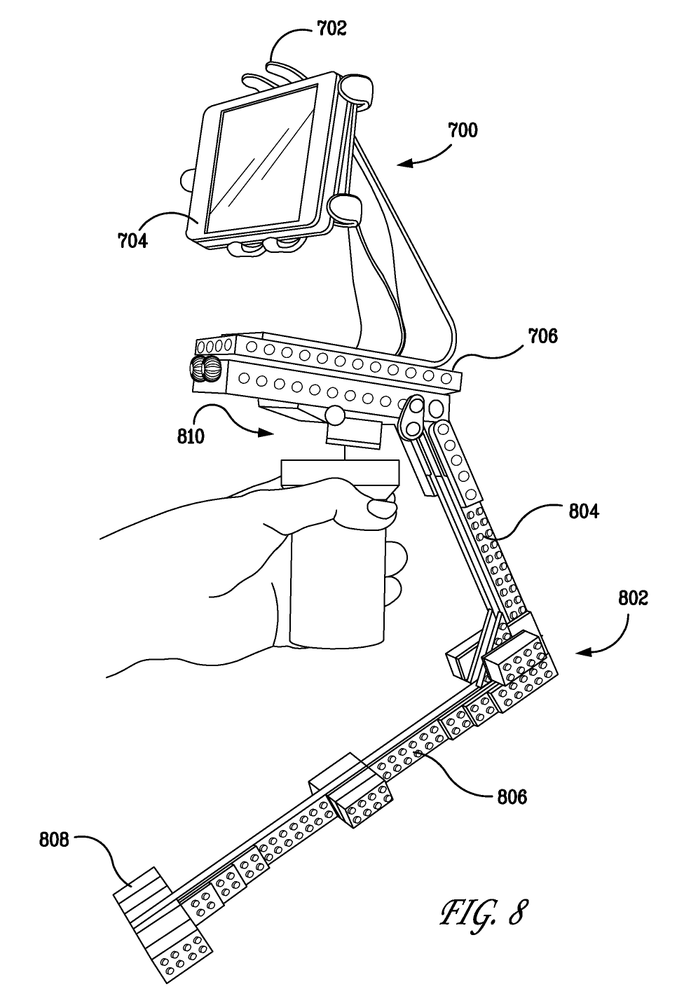

In an illustrative embodiment of the invention, as shown in FIGS. 7 and 8, a holder 700 includes a plurality of resilient brackets 702 configured to extend around at least a portion of the edges of an image-capture device 704 and allows image-capture device 704 to be snapped into holder 700. One or more resilient brackets may also be included. FIG. 7 shows five brackets, including upper and side brackets. Two bottom brackets are also partially shown. The bottom brackets, for example, may be non-resilient and the device could still be snapped into the holder. Holder 700 is attached to a base or platform 706, which can be attached to the remaining portions of stabilizer as shown in FIG. 8, either by being permanently affixed or removably attached.

In another illustrative embodiment of the invention, the holder comprises a frame having at least one open side into which the image-capture device can be slid. The opening can be for example on the top of the frame or the side. This type of holder can also have various bases or platforms, such as those described herein, either attached or incorporated therein.

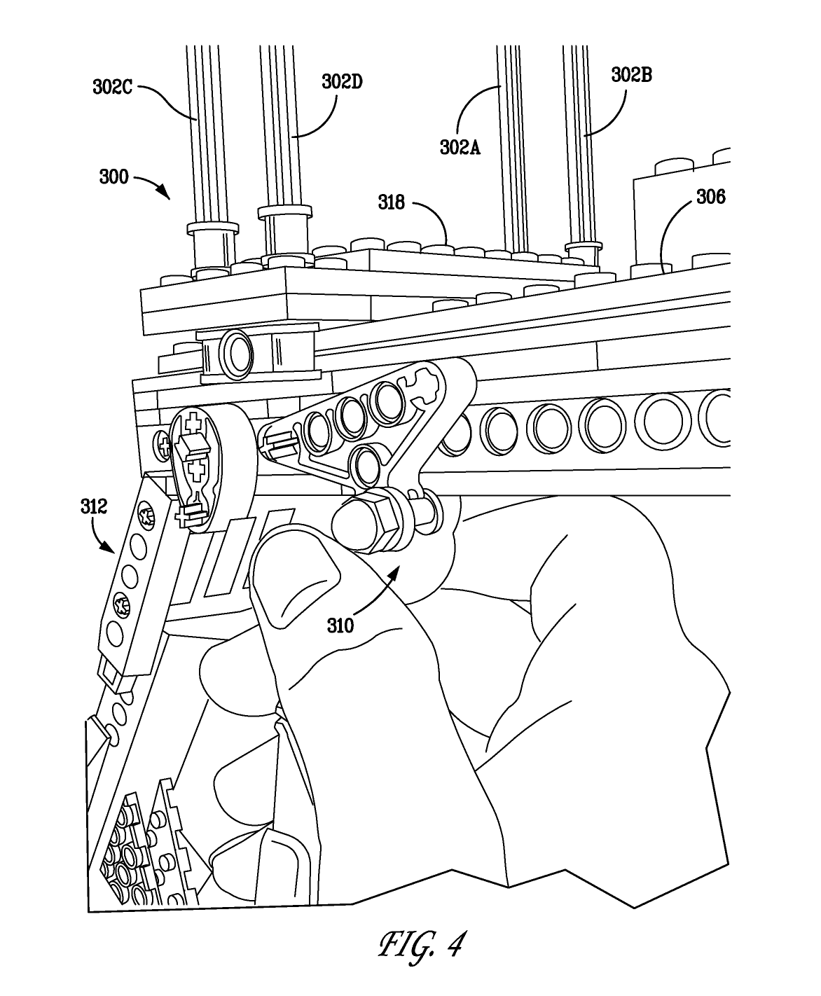

The holder is preferably substantially perpendicular to the platform for many applications, as shown in FIGS. 3-5, 7 and 8.

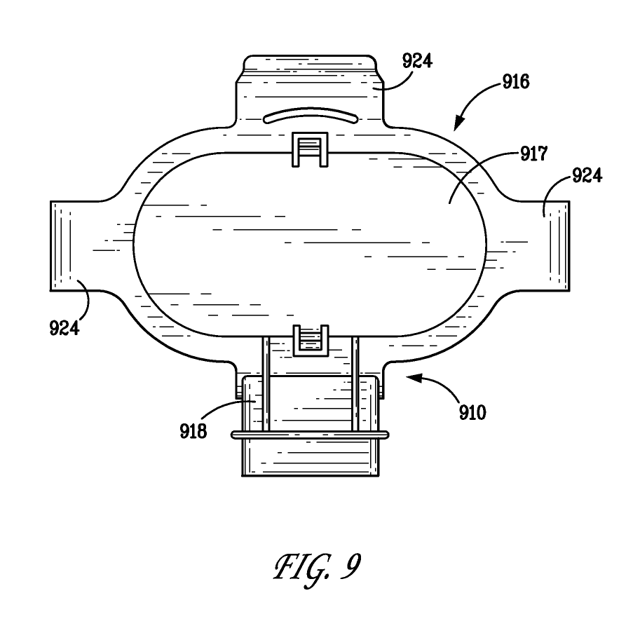

FIG. 9 depicts a holder 916 according to further illustrative embodiment of the invention. Holder 916 may be provided with one or more weights 917. These weights may be detachable or integral with the holder. Weights 917 may be positioned on the back of the holder as shown in FIG. 9, or elsewhere as necessary or desirable to balance the apparatus. Holder 916 has a base 918 that can be attached to a platform, such as for example, by being frictionally engageable with a platform. Base 918 could include for example, protrusions or recesses that would be complimentary to either protrusions or recesses on the platform. FIG. 9 also shows brackets 924 to hold an image-capture device in place.

As shown in FIGS. 1 and 2 balance arm 106 can include an upper section 122 and a lower section 124, wherein the sections are disposed end to end, and form an angle 126 with one another such that lower section 124 is angled toward or through a vertical line 128 extending through the image-capture device. Illustrative angle ranges include: about 60° to about 120°; about 75° to about 105°; and about 90° to about 100°. Angle 126 may also be adjustable, but for an apparatus that is specific to a certain device, this may not be necessary.

A support segment 130 may be included that, for example, extends from upper arm section 122 to lower arm section 124, thereby forming a triangle having as sides, at least a portion of upper arm section 122, at least a portion of lower arm section 124, and at least a portion of support segment 130. The support segment may also be of a triangular shape such as depicted in FIG. 5 as part 500.

The balancing arm may also be curved, as shown in FIG. 8, or have more than two sections and still be formed of frictionally engageable components, or components engageable through other means. FIG. 8 depicts a balancing arm 802 with an upper section 804 and a lower section 806. A weight 808 is provided at the lower most portion of lower arm section 806. A gimbal apparatus 810 is also shown.

The invention also includes methods of fabricating an image-capture device stabilizer. In an illustrative method a plurality of frictionally engageable components are provided, received or compiled that include or are engageable to form, a platform for holding a specific image-capture device, a gimbal apparatus having a handle and a gimbal apparatus that is frictionally engageable with the image-capture device platform, and positionable at the center of gravity of the image-capture device stabilizer as calculated with the image-capture device engaged thereon, and a balancing arm frictionally engageable with the image-capture device platform, the balancing arm configured for use with a specific image-capture device. Weighted components can be a part of the arm or separate components that are engaged with the apparatus. The method includes assembling the platform if it is not a single component, assembling the gimbal apparatus if not a single pre-assembled component, and attaching the gimbal apparatus to the platform. The arm and associated weighted components are also assembled and connected to the platform. Assembling includes frictionally engaging components if applicable, threadedly engaging components if applicable, or otherwise connecting the components as necessary with respect to the type of connection employed. The image-capture device stabilizer once fabricated is ideally automatically balanced for a specific image-capture device. Illustrative methods include assembling some or all of the components described herein.

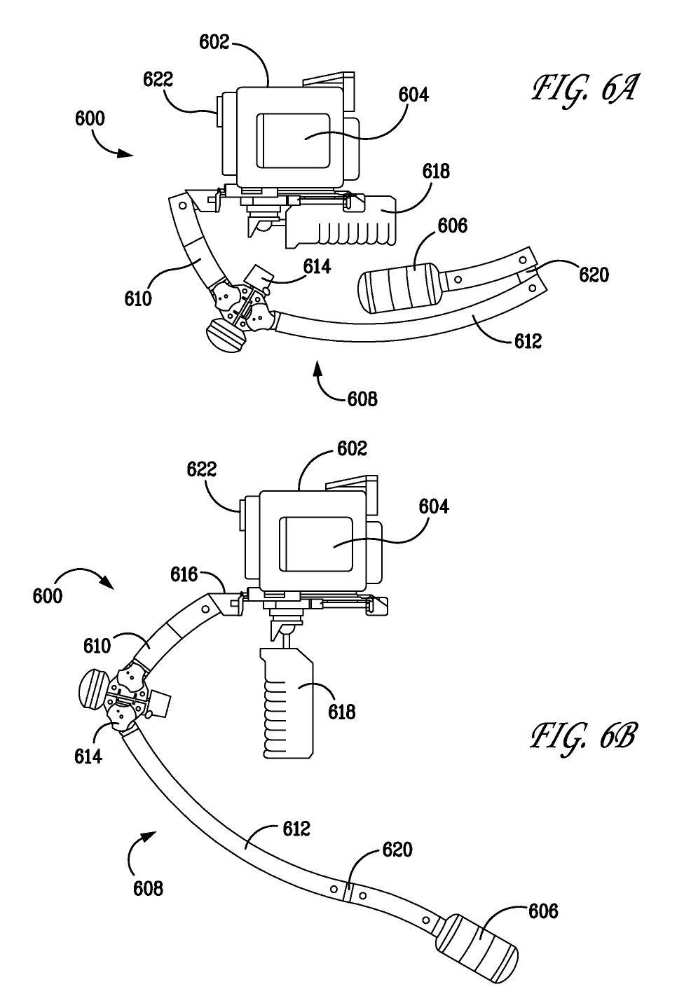

A further illustrative embodiment of the invention, such as shown in FIGS. 6A and 6B, includes a fully integrated, inclusive and pre-balanced apparatus that includes a stabilizer, image-capture device and one or more related electronic and/or mechanical components such as playback equipment, monitors, batteries, stands, connectors, lights, etc. The apparatus preferably provides dynamic and static balance of the system so as to stabilize imaging. This embodiment may also be offered as a kit, and may include attachable/detachable components, such as by being frictionally engageable for example.

FIGS. 6A and 6B depict an integrated stabilizer/device apparatus 600, wherein the device 602 is a camera. Included in this embodiment is a monitor 604 and battery 606. Additional auxiliary components can also be included, and the apparatus configured so it is properly balanced with respect to all included components.

Apparatus 600 has a balance arm 608, which can be folded toward device 602, as shown in FIG. 6A. FIG. 6B shows balance arm 608 in an unfolded position. The apparatus is designed so that when balance arm 608 is unfolded, the apparatus is automatically balanced, so that the user's motion will be isolated from motion of the camera. In this embodiment, balance arm 608 has an upper strut 610 and a lower strut 612, which are pivotable with respect to one another at pivot 614. Upper strut 610 is also pivotable at pivot 616 with respect to device 602. The battery component can also be pivotable at pivot 620.

In the illustrative embodiment shown in FIGS. 6A and 6B, gimbal apparatus 618 is disposed beneath device 602, and its handle 618 is foldable underneath it.

Weighted components can be provided at pivot 614, and battery 606 also serves as a weight. In other words, the design of each integrated apparatus can have some common components for different device models, such as the gimbal apparatus or balancing arm. To customize the apparatus for a particular device model, certain areas will be weight to achieve the proper balance. This is preferable done at the fabrication site so the unit as sold is pre-balanced.

The apparatuses, such as those shown in FIGS. 6A-B, can be modular, such as composed of frictionally engageable parts for example. This can include various image-capture device components, such as a lens 622, screen, battery, electronic components, such as would contain an integrated circuit chip for example, etc.

A fully integrated system provides more options as to weight distribution. For example, weighted components can be incorporated to increase the weight closer to the image-capture device component. Various auxiliary components can also advantageously provide different weight distribution options. Additional options for achieving the weight distribution with respect to a pivot point of a gimbal apparatus are available when the system is fully integrated. Although being fully integrated is desirable, devices can still be constructed with the ability to add components, and thus would also contain the ability to add weighted components to balance the apparatus. Auxiliary functional components can also be provided together with specific complimentary balancing components, and the original structure can be designed to readily accommodate them. For example, an integrated stabilizer/device apparatus may have a pre-configured connection point to accommodate a lighting device. The integrated apparatus could also have a pre-configured connection point to accommodate an additional weighted component to balance the lighting device. The lighting device and the balancing component can be sold separately or individually. This allows for a user to add auxiliary components while maintaining the balance of the stabilizer.

The integrated system may be configured to be foldable to provide a more compact system when not in use, or to allow the image-capture device to be more easily used without use of the stabilizer function.

The invention may be embodied in a variety of ways, for example, an apparatus, methods of fabricating or using the system, etc.

Various embodiments of the invention have been described, each having a different combination of elements. The invention is not limited to the specific embodiments disclosed, and may include different combinations of the elements disclosed.

While the invention has been described by illustrative embodiments, additional advantages and modifications will occur to those skilled in the art. Therefore, the invention in its broader aspects is not limited to specific details shown and described herein. Modifications, for example, to the stabilizer configuration, specific part geometry and materials, may be made without departing from the spirit and scope of the invention. Accordingly, it is intended that the invention not be limited to the specific illustrative embodiments, but be interpreted within the full spirit and scope of the appended claims and their equivalents.

1-27. (canceled)

28. An image-capture device stabilizer comprising:
an image-capture device holder, the image-capture device holder positioned on a platform, the platform frictionally engaged with a gimbal apparatus having a handle and a gimbal, and positioned at the center of gravity of the image-capture device stabilizer when engaged with an image-capture device;
a plurality of frictionally engaged components configurable into:
one or more balancing arms frictionally engaged with the image-capture device platform; and
one or more weighted components frictionally engaged with or a part of the balancing arm.

29. The image-capture device stabilizer of claim 28 configured for use with an image-capture device weighing less than 1 lb.

30. The image-capture device stabilizer of claim 28 wherein the image-capture device is adjustable on the platform along three axes.

31. The image-capture device stabilizer of claim 28 wherein two or more of the frictionally engaged components comprise:
one or more first frictional coupling elements in the form of protrusions; and
one or more second frictional coupling elements in the form of recesses complimentary to the protrusion;
wherein the protrusions are interchangeably insertable in the recesses.

32. The image-capture device stabilizer of claim 31 wherein:
the protrusions are spaced about ¼ inch apart from center to center; and
the recesses are spaced about ¼ inch apart from center to center.

33. The image-capture device stabilizer of claim 31 wherein the protrusions are cylindrical and have a diameter of approximately ⅛ inch.

34. The image-capture device stabilizer of claim 28 wherein:
the balance arm comprises an upper section and a lower section, wherein the sections are disposed end to end, and form an angle such that the lower section is angled toward a vertical extending through the image capture device; and
a support segment extending from the upper section to the lower section, thereby forming a triangle having as sides, at least a portion of the upper arm, at least a portion of the lower arm and at least a portion of the support segment.

35. The image capture device stabilizer of claim 28 further comprising an image-capture device, integrated with the stabilizer.

36. The image capture device stabilizer of claim 35 further comprising one or more auxiliary components integrated with the stabilizer.

37. The image-capture device stabilizer of claim 35 having a plurality of pre-configured connection points to accommodate auxiliary components and complimentary weighted component, which when connected to the stabilizer maintain the balance of stabilizer.

38. A method of fabricating an image-capture device stabilizer having:
an image-capture device holder positioned on or integral with a platform, the platform frictionally engageable with a gimbal apparatus;
a plurality of frictionally engageable components engageable to form a balancing arm frictionally engageable with the image-capture device platform;
one or more weighted component frictionally engageable with the balancing arm; and
the gimbal apparatus having a handle and a gimbal, and positionable at the center of gravity of the image-capture device stabilizer with the image-capture device engaged thereon;
the method comprising:
attaching the gimbal assembly to the platform at the center of gravity of the image-capture device stabilizer with the image-capture device engaged thereon;
assembling the plurality of frictionally engageable components to form the balancing arm; and
frictionally engaging the balancing arm to the image-capture device platform.

39. The method of claim 38 wherein the stabilizer is configured to support an image-capture device weighs less than 1 lb.

40. The method of claim 38 wherein two or more of the frictionally engageable components comprise:
one or more first frictional coupling elements in the form of protrusions; and
one or more second frictional coupling elements in the form of recesses complimentary to the protrusion;
wherein the protrusions are interchangeably insertable in the recesses.

41. The method of claim 40 wherein:
the protrusions are spaced about ¼ inch apart from center to center; and
the recesses are spaced about ¼ inch apart from center to center.

42. A kit for creating an image-capture device stabilizer comprising;
a gimbal assembly having a handle and a gimbal;
an image-capture device platform frictionally engageable with the gimbal apparatus, and positionable at the center of gravity of the image-capture device stabilizer when engaged with an image-capture device;
a plurality of frictionally engageable components configurable into a balancing arm, the balancing arm frictionally engageable with the image-capture device platform; and
one or more weighted component frictionally engageable with the balancing arm to selectively balance the stabilizer.

43. The kit of claim 42 wherein:
the stabilizer is universal to a plurality of image-capture devices

44. The kit of claim 42 further comprising an image-capture device.
